(19) United States
(12) Patent Application Publication
(10) Pub. No.: US 2026/0053253 A1
(43) Pub. Date: Feb. 26, 2026

(54) HAIR CLIPPER CLEANING DEVICE

(71) Applicant: Johansen Wilson, Meriden, CT (US)

(72) Inventor: Johansen Wilson, Meriden, CT (US)

(21) Appl. No.: 19/368,348

(22) Filed: Oct. 24, 2025

Related U.S. Application Data
(63) Continuation-in-part of application No. 17/953,450, filed on Sep. 27, 2022.

(51) Int. Cl. A45D 27/46; B26B 19/38

(52) U.S. Cl. CPC A45D 27/46; B26B 19/3833; B26B 19/3873

(57) ABSTRACT

A maintenance device for maintaining a hair clipper includes a housing having a shell that defines an interior area formed with a first port and a second port; a cleaning station disposed in the interior area and accessible via the first port, and configured to remove hair fragments from the hair clipper. The cleaning station further comprises at least one filter configured to filter the hair fragments; an applicator station disposed in the interior area and accessible via the second port, the applicator station being configured to apply at least one of a lubricant and a sanitizing agent to the hair clipper. A sensor is disposed within each of the cleaning station and the applicator station, and configured to sense, position, and indicate positioning of the hair clipper in the cleaning station and the applicator station.

### CROSS REFERENCE TO RELATED APPLICATION

This application is a continuation-in-part application of the U.S. Non-Provisional patent application Ser. No. 17/953,450 filed Sep. 27, 2022 that takes priority from the U.S. Provisional Patent Application Ser. No. 63/248,652 filed Sep. 27, 2021, the entirety of which is incorporated herein by reference.

### FIELD OF THE INVENTION

This invention relates to a cleaning device for cleaning, sanitizing, lubricating, and charging a hair clipper.

### BACKGROUND

Hair stylists use electric hair clippers (e.g., trimmers) which are specialized implements used to cut human head hair. Hair clippers use a vibrating motor that moves the blade at a high resonant frequency. The blades accumulate cut hair fragments which leads to wear and degradation of the hair clipper over time. The hair fragments can contaminate the hair clippers by carrying germs and microorganisms, especially one which causes diseases. With the spread of COVID 19, transmission of germs and microorganisms via hair clippers is of a growing concern.

Hair stylists maintain their profitability by being able to maximize the number of people they can cut hair for over a given period of time. However, the hair stylists'efficiency is reduced by the need to clean, sanitize and lubricate the hair clippers. Such cleaning, sanitizing, and lubricating is typically accomplished with devices that tend to cause the hair fragments along with any germs and microorganisms to become airborne. Moreover, health codes require sanitization of the hair clipper after use with each person.

Thus, there is a need for an improved device for cleaning, sanitizing and lubricating hair clippers that addresses the foregoing problems.

### SUMMARY

The present invention includes a maintenance device for maintaining a hair clipper including a housing having a shell that defines an interior area formed with a first port and a second port, each of the first port and the second port extends through the shell and into the interior area; a cleaning station disposed in the interior area and accessible via the first port, the cleaning station being configured to remove hair fragments from the hair clipper, the cleaning station further comprises at least one filter detachably disposed within the first port and configured to filter the hair fragments removed from the hair clipper; an applicator station disposed in the interior area and accessible via the second port, the applicator station being configured to apply a lubricant and a sanitizing agent to the hair clipper, the applicator station comprises at least one storage vessel containing at least one of the lubricant and the sanitizing agent; and a sensor disposed within each of the cleaning station and the applicator station, the sensor is configured to sense, position, and indicate positioning of the hair clipper in the cleaning station and the applicator station, respectively.

In some embodiments, the cleaning station comprises at least one blower chamber, the at least one blower chamber being configured to impart air onto the hair clipper to remove the hair fragments therefrom.

In some embodiments, the cleaning station comprises a reservoir for containing hair fragments removed from the hair clipper.

In some embodiments, the maintenance device further comprises a first holder mounted on at least one side of the housing, the first holder is configured to rigidly mount at least one communication device with the maintenance device, the at least one communication device corresponds to at least one of a mobile phone, a smart phone, a tablet, or a display device.

In some embodiments, the first holder further comprises a pair of holding pads, the pair of holding pads are collectively configured to grip and hold the at least one communication device onto the first holder.

In some embodiments, the maintenance device further comprises at least one charging cord having one end monolithically coupled to the housing and another end detachably configured to plug with the at least one communication device or the hair clipper for charging.

In some embodiments, the maintenance device further comprises a second holder mounted on at least other side of the housing, the second holder is configured to rigidly mount more than one hair clippers.

In some embodiments, the maintenance device further comprises a mounting unit formed on the housing, the mounting unit is configured to mount the maintenance device on a fixed surface.

In some embodiments, the maintenance device further comprises at least one magnet disposed within the interior area of the housing and configured for attaching the at least one storage vessel onto the interior area of the housing.

In some embodiments, the maintenance device further comprises at least one button disposed over the housing, the at least one button is configured to operate the cleaning station and the applicator station.

In some embodiments, the housing is manufactured from a plastic material.

The present invention includes a method for a maintenance device comprising forming a first port and a second port in an interior area of a shell of a housing, wherein each of the first port and the second port extends through the shell and into the interior area; disposing a cleaning station in the interior area and accessible via the first port, the cleaning station being configured to remove hair fragments from the hair clipper; disposing detachably at least one filter within the first port, the at least one filter being configured to filter the hair fragments removed from the hair clipper; disposing an applicator station in the interior area and accessible via the second port, the applicator station being configured to apply at least one of a lubricant and a sanitizing agent to the hair clipper, wherein the applicator station comprises at least one storage vessel containing the at least one of a lubricant and the sanitizing agent; and disposing a sensor within each of the cleaning station and the applicator station, wherein the sensor is configured to sense, position, and indicate positioning of the hair clipper in the cleaning station and the applicator station, respectively.

### BRIEF DESCRIPTION OF THE DRAWINGS

FIG. 1 is a perspective view of the maintenance device for maintaining a hair clipper of the present invention;

FIG. 2 is a photograph of the device of the present invention;

FIG. 3 is a perspective view of another embodiment of the maintenance device for maintaining a hair clipper of the present invention;

FIG. 4 is a perspective phantom view of a portion of the inside of the maintenance device for maintaining a hair clipper of the present invention;

FIG. 5 is a perspective phantom view of a portion of the inside of the maintenance device for maintaining a hair clipper of the present invention;

FIG. 6 is a perspective view of the perspective phantom view of the maintenance device for maintaining a hair clipper of the present invention shown with a drawer and door open;

FIG. 7 is a perspective view of the perspective phantom view of a portion of the maintenance device for maintaining a hair clipper of the present invention shown with a drawer and door closed;

FIG. 8A is an isolated view of a cleaning station of FIG. 7;

FIG. 8B is an isolated view of an applicator station of FIG. 7;

FIG. 8C is an isolated view of the charging station of FIG. 7;

FIG. 8D is a perspective view of a portion of the interior area of the maintenance device for maintaining a hair clipper of FIG. 7.

FIG. 9 is an isometric view of a maintenance device for maintaining the hair clipper;

FIG. 10 is an exploded view of the maintenance device for maintaining the hair clipper of FIG. 9; and

FIG. 11 is an exemplary view of the maintenance device for maintaining the hair clipper of FIG. 9.

FIG. 12 is a flowchart showing a method for forming a maintenance device for maintaining the hair clipper;

### DETAILED DESCRIPTION

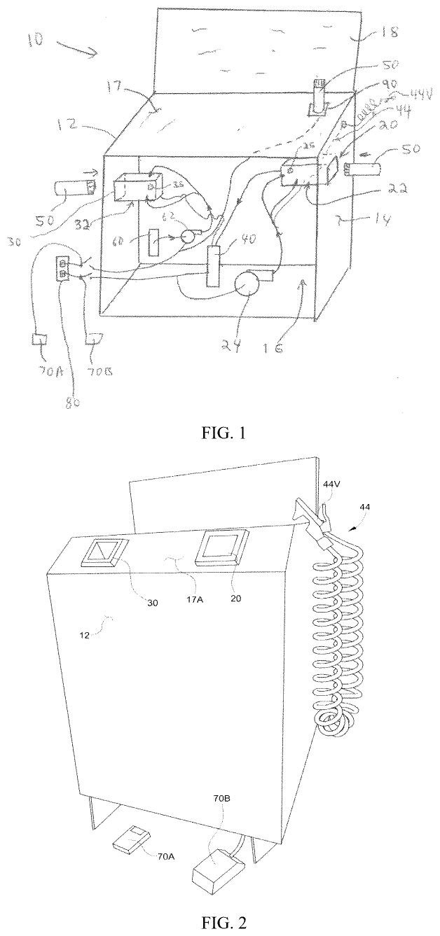

As shown in FIG. 1, a maintenance device for maintaining (e.g., cleaning, charging and sanitizing) a hair clipper is generally designated by the numeral 10. The maintenance device 10 includes a housing 12 having a shell 14 that defines an interior area 16. The housing 12 has a horizontal working surface 17 for placing hair cutting devices and equipment. A mirror 18 is mounted vertically to the housing 12. In some embodiments, the housing 12 is manufactured from a plastic material. In some embodiments, the housing 12 is manufactured from a metallic material. In some embodiments, the housing 12 is manufactured from a combination of one or more plastic materials and one or more metallic materials. While the maintenance device 10 is shown and described for maintaining a hair clipper, the present invention is not limited in this regarding as the maintenance device 10 is configured to maintain other devices, including but not limited to combs, scissors, cell phones, tools, keys, handheld devices, beverage cans, eating utensils, and food containers.

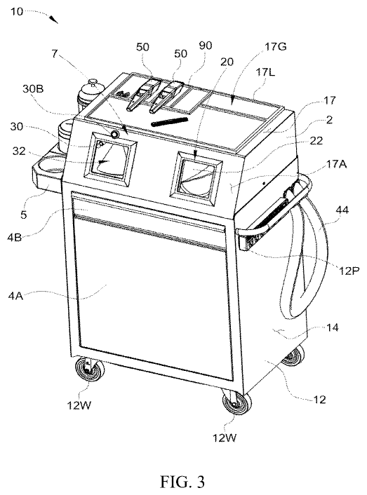

A first port 20 extends through the shell 14 and into the interior area 16. For example, in FIG. 1 the first port 20 is shown extending through the shell 14 on the right-hand side of the housing 12. However, the present invention is not limited in this regard as the first port 20 may extend through the shell 14 in any other location including the front side (see FIGS. 2 and 3), the left-hand side and the top of the housing 12. A cleaning station 22 is disposed in the interior area 16 and accessible via the first port 20. The cleaning station 20 is configured to remove hair fragments from the hair clipper 50. The first port 20 is sized to receive the hair clipper 50 for cleaning the hair clipper 50.

The maintenance device 10 includes an applicator station 32 disposed in the interior area 16 and accessible via a second port 30. For example, the second port 30 is shown extending through the shell 14 on the left-hand side of the housing 12. However, the present invention is not limited in this regard as the second port 30 may extend through the shell 14 in any other location including the front side (see FIGS. 2 and 3) , the right-hand side and the top of the housing 12. The applicator station 32 is configured to apply one or more substances to the hair clipper 50. The second port 30 is sized to receive the hair clipper 50 for applying a lubricant and/or sanitizing agent (e.g., an ethyl alcohol or isopropyl alcohol based disinfectant, sodium hypochlorite, hydrogen peroxide or a virucidal agent) to the hair clipper 50. The sanitizing agent is configured to chemically destroy germs, bacteria and particles containing influenza, COVID, lipophilic viruses or other diseases. In some embodiments, the sanitizing agent is an ultraviolet (UV) light source configured to inactivate and destroy germs, microbes, bacteria and particles containing influenza, COVID or other diseases

The cleaning station 22 includes a gas supply source 24 in communication therewith. The gas supply source 22 is configured to impart a gas, preferably air, onto the hair clipper 50 when positioned in the cleaning station 22 through the first port 20, to remove hair fragments therefrom. The cleaning station 22 includes a reservoir 40 for containing hair fragments removed from the hair clipper 50 and deposited in the cleaning station 22. In some embodiments, the reservoir 40 includes a vacuum for suctioning hair fragments from the hair clipper 50. In some embodiments, the gas supply 24 is a compressor, a blower and/or a canister of a pressurized gas, for supplying a gas such as air or nitrogen to the cleaning station 22. As best shown in FIG. 2, an auxiliary line 44 (e.g., flexible hose coil or retractable hose reel) is in communication with the gas supply source 24 or a vacuum. The auxiliary line 44 has a valve 44V positioned in a terminal end thereof. The auxiliary line 44 and valve 44V have utility in further cleaning of the maintenance device 10, the hair clipper 50 and hair cutting devices and equipment.

As shown in FIG. 2, the housing 14 includes a sloped surface 17A that extends between the horizontal working surface 17 and the front of the housing 12. The first port 20 and the second port 30 extend through the sloped surface 17A, and the cleaning station 22 and the applicator station 32 are oriented generally perpendicular to the sloped surface 17A to urge hair fragments and excess fluids to slide to a bottom portion of the respective one of the cleaning station 22 and the applicator station 32, where they can be removed via a suitable discharge device such as the reservoir 40.

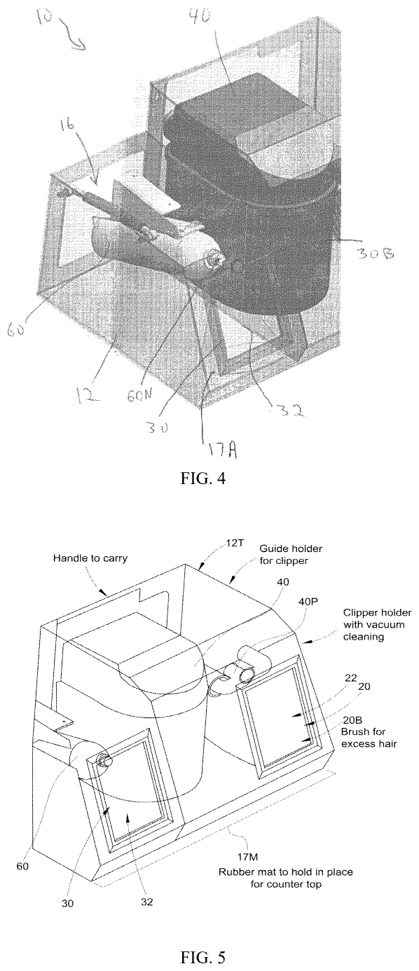

The applicator station 32 includes a storage vessel 60 that contains a fluid such as a lubricant and/or a sanitizing agent. The applicator station 32 includes a conveying device 62 such as a pump that is in communication with the storage vessel 60 and the applicator station 32. The conveying device 62 is configured to transfer the lubricant and sanitizing agent onto the hair clipper 50 when the hair clipper is positioned in the applicator station 32 via the second port 30, to apply (e.g., spray) the lubricant and/or sanitizing agent onto the hair clipper 50. The applicator station 32 is in communication with the reservoir 40 to remove excess fluids accumulated in the applicator station 32. As shown in FIGS. 3 and 4, the conveying device 60 is a replaceable canister that contains the lubricant and/or sanitizing agent under pressure. The canister includes a spray nozzle 60N that is configured to spray the lubricant and/or sanitizing agent on the hair clipper 50. In some embodiments, the spray nozzle 60N is activated by a button 20B located proximate the second port 30. The conveying device 60 (i.e., canister) can be removed when it is empty and a full conveying device 60 (i.e., canister) can be installed in the interior area 16.

The cleaning station 22 and the applicator station 32 are remotely operated, preferably by a foot pedal or a button 70A, 70B that is in communication with a power supply 80 and the cleaning station 22 and the applicator station 32.

While the cleaning station 22 and the applicator station 32 are accessible via separate ports (i.e., the first port 20 and the second port 30, respectively), the present invention is not limited in this regard as the cleaning station 22 and the applicator station 32 may be accessible via a single common port.

The cleaning station 22 and the applicator station 32 each have a sensor 25, 35, respectively, that senses, positions and indicates proper positioning of the hair clipper 50 in the cleaning station 22 and the applicator station 32. In some embodiments, the sensor 25 activates the gas supply source 24 or vacuum. In some embodiments, the sensor 35 activates the conveying device 62 to transfer the lubricant and sanitizing agent from the storage vessel 60 onto the hair clipper 50. In some embodiments, the sensors 25 and 35 are motion sensors.

In some embodiments, the maintenance device for maintaining a hair clipper 10 includes a charging station 90 located on the horizontal working surface 17 and in communication with the power supply 80. The charging station 90 is configured to charge or power the hair clipper 50. In some embodiments, the charging station 90 is formed integral with the housing 12. In some embodiments, the charging station 90 is formed integral with the horizontal working surface 17.

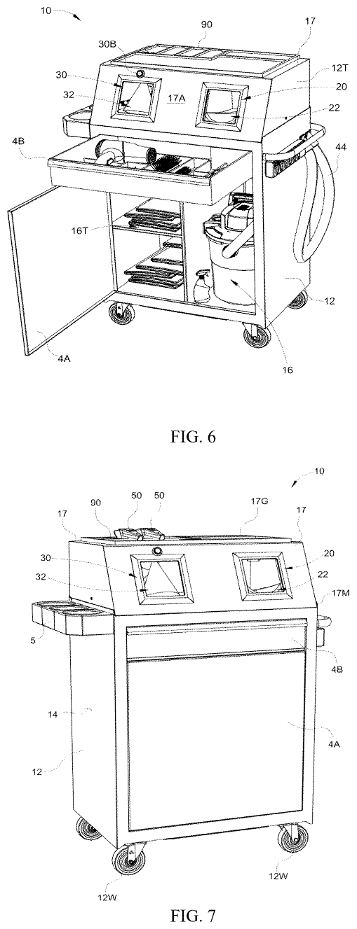

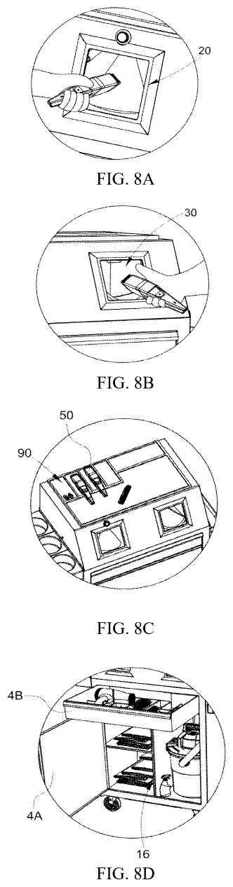

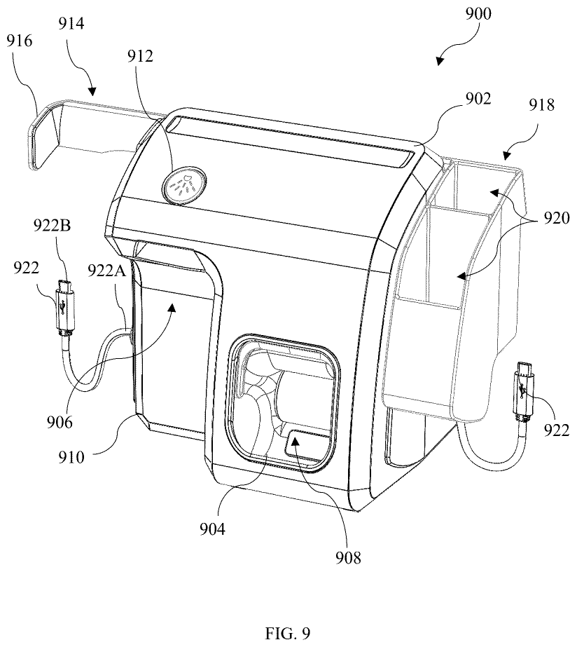

While the cleaning station 22 and the applicator station 32 are shown and described as being positioned in ports 20 and 30, respectively, in the housing 12, the present invention is not limited in this regard as the cleaning station 22 and the applicator station 32 may be configured as a separate compact stand-alone assembly, for example that is shelf or wall mounted. For example, as shown in FIG. 3 the cleaning station 22 and the applicator station 32 are housed in an enclosure 2 that is positioned on the housing 12. An anti-slip mat 17M is disposed between the enclosure 2 and the housing 12 to assist in securing the enclosure 2 to the housing 12. As shown in FIG. 3, the enclosure 2 includes a sloped front face 7 in which the first port 20 and the second port 30 extend through. In some embodiments the housing is mounted on wheels 12W to facilitate repositioning of the maintenance device for maintaining a hair clipper 10. As shown in FIGS. 3, 6 and 7 the housing 12 includes a door 41 that is mounted to the housing on hinges to provide access to the interior area 16 of the housing 12. In some embodiments, the interior includes shelves 16T (see FIG. 6) . In some embodiments, the housing 12 includes a drawer 4B that is slidable into and out of the housing 12. In some embodiments, the housing 12 includes a power supply 12P mounted thereto as shown in FIG. 3. In some embodiments, the housing 12 includes an exterior shelf 5 mounted to a side thereof.

As shown in FIG. 3 a platform 17G that has a lip system 17L thereon is disposed on the top surface 17 to provide containment for articles such as the hair clipper 50 on the platform 17G. In some embodiments, the platform 17G includes the charging station 90.

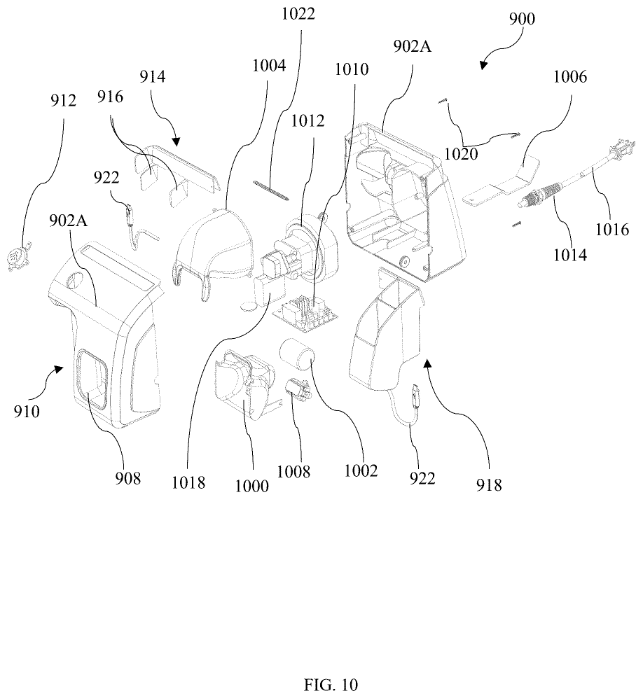

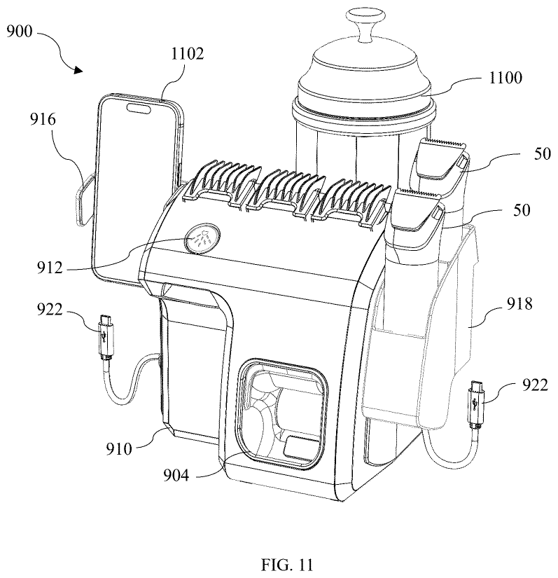

As shown in FIG. 9, an isometric view of a maintenance device 900 for maintaining the hair clipper 50 is disclosed. FIG. 10 is an exploded view of the maintenance device 900 for maintaining the hair clipper 50 of FIG. 9.

In some embodiments, the maintenance device 900 may comprise a housing 902 having a shell that defined an interior area. In some embodiments, the interior area may further be formed with a first port 904 and a second port 906. In some embodiments, each of the first port 904 and the second port 906 may extend through the housing 902 and into the interior area. The housing 902 may comprise a front housing 902A and a rear housing 902B.

Further, as shown in FIG. 9, the housing 902 may define the first port 904 extending through the shell and into the interior area. The first port 904 is generally square or slightly rectangular in shape and includes rounded edge transitions to blend smoothly with the surrounding surface of the shell. The first port 904 is recessed relative to the outer contour of the shell to form a shallow cavity bordered by a continuous perimeter wall. The perimeter of the first port 904 may include a molded lip or shoulder configured to retain a cover, insert, or transparent window component. An inner boundary of the first port 904 extends in a substantially perpendicular orientation relative to a front wall of the shell, defining a clean, framed aperture that provides visual and physical access to the corresponding interior region while maintaining the aesthetic continuity of the housing 902.

In some embodiments, the second port 906 extends inwardly through a thickness of the shell to communicate with the interior area of the housing 902. In the illustrated embodiment, the second port 906 is generally rectangular in outline with radiused corner transitions and an inwardly chamfered rim that tapers toward the interior area to facilitate alignment with a corresponding mating interface. The perimeter of the second port 906 may include a recessed lip or flange region. The second port 906 is positioned symmetrically relative to a central vertical plane of the housing 902 and is bounded by continuous wall surfaces that are molded as one piece with the shell, thereby providing a smooth, continuous exterior contour without separate fasteners or inserts.

In some embodiments, the maintenance device 900 further comprises a cleaning station 908. In some embodiments, the cleaning station 908 is disposed in the interior area and is accessible via the first port 904. In some embodiments, the cleaning station 908 is configured to remove hair fragments from the hair clipper 50. In some embodiments, the cleaning station 908 comprises at least one blower chamber 1000 (shown in FIG. 10). In some embodiments, the blower chamber 1000 is configured to impart air onto the hair clipper 50 positioned at the cleaning station 908 to remove the hair fragments from the hair clipper 50. Further, the cleaning station 908 comprises the reservoir 40. In some embodiments, the reservoir 40 is configured to contain the hair fragments removed from the hair clipper 50. Further, the blower chamber 1000 is fluidly coupled to a blower motor 1012 configured to generate the air imparted through the blower chamber 1000, to the hair clipper 50.

In some embodiments, the cleaning station 908 further comprises at least one filter 1002 (shown in FIG. 10). In some embodiments, the at least one filter 1002 is detachably disposed within the first port 904. In some embodiments, the at least one filter 1002 is configured to filter the hair fragments removed from the hair clipper 50. In some embodiments, the filter 1002 may comprise a fine mesh or porous medium that permits passage of air or cleaning fluid while capturing particulate debris. The hair fragments may get accumulated on an upstream surface of the fine mesh or porous medium, which may be periodically removed or rinsed for maintenance. In certain implementations, the filter 1002 may be detachably mounted within a filter holder or cartridge accessible through an exterior access panel of the housing 902.

In some embodiments, the housing 902 further comprises an applicator station 910. In some embodiments, the applicator station 910 may be disposed in the interior area and accessible via the second port 906. In some embodiments, the applicator station 910 is configured to apply at least one of a lubricant and a sanitizing agent to the hair clipper 50. Further, the applicator station may comprise at least one storage vessel 1100 (shown in FIG. 11). The storage vessel may comprise the at least one of the lubricant and the sanitizing agent. In some embodiments, the applicator station 910 further comprises a nozzle 1004 (shown in FIG. 10). In some embodiments, the nozzle 1004 may be fluidly coupled to the at least one storage vessel 1100. In some embodiments, the nozzle 1004 may be configured to dispense the lubricant and the sanitizing agent from the at least one storage vessel 1100 and onto the hair clipper 50.

Further, the housing 902 further comprises at least one button 912 disposed over the housing 902. In some embodiments, the at least one button 912 may be configured to operate the cleaning station and the applicator station. In some embodiments, the housing 902 further comprises at least one storage vessel holder 1006. In some embodiments, the at least one storage vessel holder 1006 is configured to rigidly mount the at least one storage vessel 1100 with the housing 902. In some embodiments, the housing 902 further comprises a sensor 1008 (shown in FIG. 10). In some embodiments, the sensor 1008 may be disposed within each of the cleaning station 908 and the applicator station 910. In some embodiments, the sensor 1008 is configured to sense, position, and indicate positioning of the hair clipper 50 in the cleaning station 908 and the applicator station 910.

Further, the sensor 1008 may be communicatively coupled to printed circuit board 1010. In some embodiments, the printed circuit board (PCB) 1010 may be disposed within the housing 902. In some embodiments, the sensor 1008 may operate using optical, magnetic, proximity, or mechanical detection principles to sense insertion or correct seating of the clipper. Upon detecting the hair clipper 50, the sensor 1008 may generate a signal to the PCB 1010 to confirm proper positioning and initiate the corresponding cleaning or applicator cycle. In certain implementations, the sensor 1008 may also provide a visual or electronic indication, such as an LED or status signal, confirming that the hair clipper 50 is correctly positioned within the respective station.

In some embodiments, the sensor 1008 may be configured to detect positioning of the hair clipper 50 through one or more sensing modalities integrated within each of the cleaning station 908 and the applicator station 910. For example, the sensor 1008 may include an infrared (IR) proximity emitter-receiver pair or an optical photodiode array arranged to detect reflection or interruption of a light beam when the hair clipper 50 is inserted into the station. In other embodiments, the sensor 1008 may comprise a magnetic Hall-effect element or reed switch that cooperates with a magnetic portion or embedded magnet in the clipper to confirm proper alignment. Mechanical microswitches or pressure-sensitive elements may also be positioned along guide walls or seating surfaces to sense when the hair clipper 50 is fully seated. The PCB 1010 may interpret the resulting sensor signals to determine whether the hair clipper 50 is correctly positioned for cleaning or application, and may activate an indicator such as an LED, display icon, or audible signal to confirm correct placement to the user. In one embodiment, the sensor 1008 may be used to sense or effect automatic dispensing of the spray.

In one embodiment, the maintenance device 900 may include a receptacle (a holding device or a holding element), including the sensor 1008, that senses placement of the hair clipper 50 in the receptacle to effect automatic dispensing of the spray. It may be noted that the sensor 1008 may have similar operations/functionality or be same as sensors 25 and 35 (as shown in the drawings) without departing from the scope of the disclosure.

In some embodiments, the maintenance device 900 further comprises a first holder 914 mounted on at least one side of the housing 902. In some embodiments, the first holder 914 is configured to rigidly mount at least one communication device 1102 (shown in FIG. 11) with the maintenance device 900. In some embodiments, the at least one communication device 1102 corresponds to at least one of a mobile phone, a smart phone, a tablet, or a display device. Further, the first holder 914 comprises a pair of holding pads 916. In some embodiments, the pair of holding pads 916 are collectively configured to grip and hold the at least one communication device 1102 onto the first holder 914.

In some embodiments, the maintenance device 900 further comprises a second holder 918. In some embodiments, the second holder 918 is mounted on at least other side of the housing 902. In some embodiments, the second holder 918 is configured to rigidly mount the hair clipper 50 as shown in FIG. 11. In some embodiments, the second holder 918 may be fabricated with a plurality of cavities 920. In some embodiments, the plurality of cavities 920 may be configured to equip multiple hair clippers.

Further, the maintenance device 900 comprises at least one charging cord 922. In some embodiments, one end 922A of the at least one charging cord 922 may be monolithically coupled to the housing 902 and another end 922B of the at least one charging cord 922 may be detachably configured to plug with the at least one communication device 1102 or the hair clipper 50 for charging. Further, the at least one charging cord 922 may comprise at least one cord grip 1014.

In some embodiments, the cord grip 1014 may be formed as an integrally molded strain-relief element positioned at a junction where the charging cord 922 exits the housing 902 to prevent excessive bending or pulling stress on the internal electrical connections. The cord grip 1014 may include an annular collar, flexible ribbed sleeve, or clamping bracket that partially encloses an outer surface of the charging cord 922. In certain implementations, the cord grip 1014 may be detachably mounted or elastomerically fitted to allow replacement of the charging cord 922 while maintaining a sealed or protected interface with the housing 902. Further, the cord grip 1014 may be electrically coupled to a power cord 1016 for providing electrical energy to the at least one charging cord 922.

Further, the housing comprises a mounting unit (not shown) configured to mount the maintenance device 900 on a fixed surface (e.g. wall) or fixtures 1020. Further, the maintenance device 900 comprises at least one magnet 1018. In some embodiments, the at least one magnet 1018 may be configured to be disposed within the interior area of the housing 902. Further, the at least one magnet 1018 may be configured for attaching the at least one storage vessel 1100. The at least one magnet 1018 may correspond to a neodymium magnet. Further, the housing 902 may be manufactured from a plastic material. The housing further comprises a splitter.

The splitter may include a molded or enclosed housing having an input port connected to the charging cord 922 and two or more output leads extending therefrom. In one implementation, a first output lead may supply electrical power to the PCB 1010 of the maintenance device 900, while a second output lead may provide charging current to the hair clipper 50 when docked. The splitter may further incorporate strain-relief features or protective sheathing similar to the cord grip 1014 to prevent cable fatigue and ensure reliable electrical coupling. In some embodiments, the splitter may be positioned externally along the power cord 1016 or integrally within the housing 902 of the maintenance device 900. Further, the housing 902 comprises extension spring 1022. The extension spring 1022 may be configured to extend or retract the first holder 914 from the housing 902.

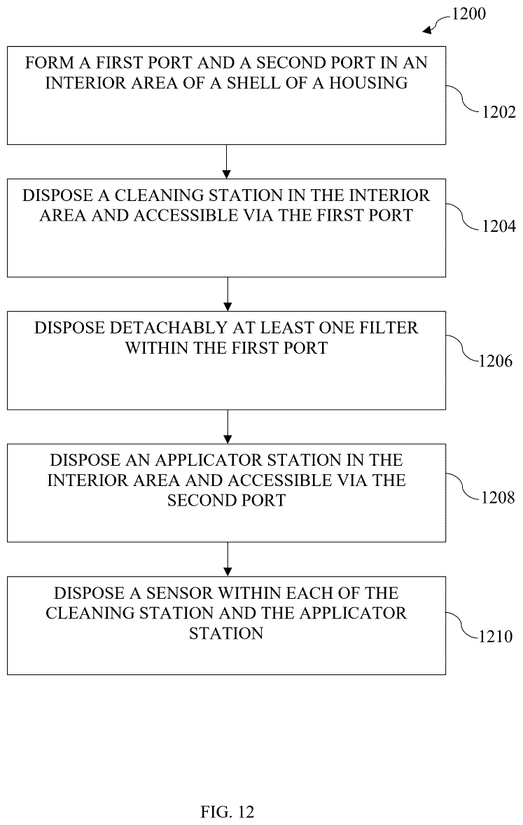

FIG. 12 shows a flowchart for a method for forming the maintenance device 900.

At operation 1202, the first port 904 and the second port 906 is formed in the interior area of the shell of the housing 902. In some embodiment, each of the first port 904 and the second port 906 extends through the shell and into the interior area.

At operation 1204, the cleaning station 908 is disposed in the interior area and accessible via the first port 904. In some embodiment, the cleaning station 908 being configured to remove hair fragments from the hair clipper 50.

At operation 1206, at least one filter 1002 is detachably disposed within the first port 904. In some embodiments, the at least one filter 1002 being configured to filter the hair fragments removed from the hair clipper 50.

At operation 1208, the applicator station 910 is disposed in the interior area and accessible via the second port 906. In some embodiments, the applicator station 910 being configured to apply at least one of a lubricant and a sanitizing agent to the hair clipper 50. In some embodiments, the applicator station 910 comprises the at least one storage vessel 1100 containing the at least one of a lubricant and the sanitizing agent.

At operation 1210, the sensor 1008 is disposed within each of the cleaning station 908 and the applicator station 910. In some embodiments, the sensor 1008 is configured to sense, position, and indicate positioning of the hair clipper 50 in the cleaning station 908 and the applicator station 910, respectively.

The maintenance device 900 disclosed herein provides a compact and integrated solution for cleaning, sanitizing, and maintaining the hair clipper 50 within the housing 902. By incorporating both a cleaning station and an applicator station accessible through dedicated ports in the housing shell, the maintenance device 900 minimizes user effort and reduces the need for separate maintenance accessories. The inclusion of detachable filters enables efficient collection and removal of hair fragments, while the applicator station ensures consistent application of lubricants or sanitizing agents to prolong blade performance and hygiene.

The integration of sensors within each station allows precise positioning and automatic operation when the hair clipper is properly seated, thereby enhancing safety and ease of use. Additional structural features such as holders for communication devices and clippers, a charging cord with integrated grip, and an optional splitter contribute to user convenience and organized storage. Furthermore, the modular housing design with magnetic attachments and mounting provisions facilitates stable installation and easy access to internal components. Collectively, these features improve maintenance efficiency, promote user hygiene, and extend the operational lifespan of the hair clipper through an automated and user-friendly maintenance process.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A maintenance device for maintaining a hair clipper, the maintenance device comprising:
a housing having a shell that defines an interior area formed with a first port and a second port, wherein each of the first port and the second port extends through the shell and into the interior area;
a cleaning station disposed in the interior area and accessible via the first port, the cleaning station being configured to remove hair fragments from the hair clipper, wherein the cleaning station further comprises:
at least one filter detachably disposed within the first port and configured to filter the hair fragments removed from the hair clipper;
an applicator station disposed in the interior area and accessible via the second port, the applicator station being configured to apply at least one of a lubricant and a sanitizing agent to the hair clipper; and
a sensor disposed within each of the cleaning station and the applicator station, wherein the sensor is configured to sense, position, and indicate positioning of the hair clipper in the cleaning station and the applicator station, respectively.

2. The maintenance device of claim 1, wherein the cleaning station comprises at least one blower chamber, the at least one blower chamber being configured to impart air onto the hair clipper to remove the hair fragments therefrom.

3. The maintenance device of claim 1, wherein the cleaning station comprises a reservoir for containing the hair fragments removed from the hair clipper, and the applicator station comprises at least one storage vessel containing the at least one of the lubricant and the sanitizing agent.

4. The maintenance device of claim 1 further comprising a first holder mounted on at least one side of the housing, wherein the first holder is configured to rigidly mount at least one communication device with the maintenance device, wherein the at least one communication device corresponds to at least one of a mobile phone, a smart phone, a tablet, or a display device.

5. The maintenance device of claim 4, wherein the first holder further comprises a pair of holding pads, wherein the pair of holding pads are collectively configured to grip and hold the at least one communication device onto the first holder.

6. The maintenance device of claim 4 further comprising at least one charging cord having one end monolithically coupled to the housing and another end detachably configured to plug with the at least one communication device or the hair clipper for charging.

7. The maintenance device of claim 1 further comprising a second holder mounted on at least other side of the housing, wherein the second holder is configured to rigidly mount more than one hair clippers.

8. The maintenance device of claim 1 further comprising a mounting unit formed on the housing, wherein the mounting unit is configured to mount the maintenance device on a fixed surface.

9. The maintenance device of claim 3 further comprising at least one magnet disposed within the interior area of the housing and configured for attaching the at least one storage vessel onto the interior area of the housing.

10. The maintenance device of claim 1 further comprising at least one button disposed over the housing, wherein the at least one button is configured to operate the cleaning station and the applicator station.

11. The maintenance device of claim 1, wherein the housing is manufactured from a plastic material.

12. A method for forming a maintenance device, the method comprising:
forming a first port and a second port in an interior area of a shell of a housing, wherein each of the first port and the second port extends through the shell and into the interior area;
disposing a cleaning station in the interior area and accessible via the first port, the cleaning station being configured to remove hair fragments from the hair clipper;
disposing detachably at least one filter within the first port, the at least one filter being configured to filter the hair fragments removed from the hair clipper;
disposing an applicator station in the interior area and accessible via the second port, the applicator station being configured to apply at least one of a lubricant and a sanitizing agent to the hair clipper; and
disposing a sensor within each of the cleaning station and the applicator station, wherein the sensor is configured to sense, position, and indicate positioning of the hair clipper in the cleaning station and the applicator station, respectively.

13. The method of claim 12, wherein the cleaning station comprises at least one blower chamber, the at least one blower chamber being configured to impart air onto the hair clipper to remove the hair fragments therefrom.

14. The method of claim 12, wherein the cleaning station comprises a reservoir for containing the hair fragments removed from the hair clipper, and the applicator station comprises at least one storage vessel containing the at least one of the lubricant and the sanitizing agent.

15. The method of claim 12 further comprising mounting a first holder on at least one side of the housing, wherein the first holder rigidly mounts at least one communication device with the maintenance device, wherein the at least one communication device corresponds to at least one of a mobile phone, a smart phone, a tablet, or a display device.

16. The method of claim 15, wherein the first holder further comprises a pair of holding pads, wherein the pair of holding pads are collectively configured to grip and hold the at least one communication device onto the first holder.

17. The method of claim 15, wherein the maintenance device further comprises at least one charging cord having one end monolithically coupled to the housing and another end detachably configured to plug with the at least one communication device or the hair clipper for charging.

18. The method of claim 12, further comprising mounting a second holder on at least other side of the housing, wherein the second holder is configured to rigidly mount more than one hair clippers.

19. The method of claim 12, further comprising forming a mounting unit on the housing, wherein the mounting unit is configured to mount the maintenance device on a fixed surface.

20. The method of claim 14, further comprising disposing at least one magnet within the interior area of the housing and configured for attaching the at least one storage vessel onto the interior area of the housing.
